(19) United States
(12) Patent Application Publication
(10) Pub. No.: US 2010/0116477 A1
(43) Pub. Date: May 13, 2010

(54) ASSEMBLY OF BAFFLES AND SEALS AND METHOD OF ASSEMBLING A HEAT EXCHANGER

(76) Inventor: Dominicus Fredericus Mulder, Amsterdam (NL)

Correspondence Address: SHELL OIL COMPANY, P O BOX 2463, HOUSTON, TX, 772522463, US

(21) Appl. No.: 12/518,893

(22) PCT Filed: Dec. 12, 2007
(86) PCT No.: PCT/EP07/63760

§ 371 Date: Jul. 20, 2009

(30) Foreign Application Priority Data
Dec. 14, 2006 (EP) 06126093.1

(51) Int. Cl. F28F 9/22; B21D 53/02; B23P 11/00

(52) U.S. Cl. 165/160; 29/890.03; 29/428

(57) ABSTRACT

An assembly (1) of baffles and seals for mounting in a heat exchanger shell (4), which assembly (1) comprises a plurality of longitudinal baffles (6,7); at least one longitudinal seal (14,16,17), wherein the assembly (1) further comprises a wall member (21, 22) that is arranged to extend between spaced apart longitudinal baffles (6,7) so as to form a double wall with the heat exchanger shell (4) after mounting, and wherein the at least one longitudinal seal (14,16,17) is arranged on the wall member (21, 22) and away from the longitudinal baffles (6,7) so as to sealingly engage the wall member (21, 22) against the heat exchanger shell (4) after mounting.

### FIELD OF THE INVENTION

The present invention relates to an assembly of baffles and seals and to its use in a method of assembling a heat exchanger.

### BACKGROUND OF THE INVENTION

A shell-and-tube heat exchanger is an indirect heat exchanger. Heat is transferred between a fluid passing through the tubes of a tube bundle (the tube side) extending in the heat exchanger shell, and a fluid passing through the space outside the tubes (the shell side). Details of the shell-and-tube heat exchangers can for example be found in Perry's Chemical Engineers' Handbook, 6^{th} edition, 1984, McGraw-Hill Inc., page 11-3 to 11-21.

A particular type of heat-exchanger known as two-shell-pass heat exchanger has been developed for improved transfer of heat in a given shell size. In this type of heat exchanger a generally cylindrical outer tube is provided internally with an axially and longitudinally extending partition baffle. Such shell types include the two-pass shell with longitudinal baffle, the split-flow shell, and the double split-flow shell in Perry's. The longitudinal baffle subdivides the interior of the shell into two separate longitudinally extending compartments that normally communicate at one end of the shell, so that the fluid flow in the shell passes twice along the length of the shell.

For most efficient heat exchange the baffle should form a relatively tight seal along both of its longitudinal rims so that flow between the compartments is only possible in the intended regions, that is at the end or ends of the shell.

Typically, such a structure has been formed by using a rectangular partition plate having a width slightly smaller than the internal diameter of the wall of the shell so that the longitudinal outer rims of this plate are spaced slightly radially inwardly from the inner wall surface of the shell, when the plate is positioned on a diametral plane.

Several types of longitudinal seals have been developed in the past. Except for sufficient sealing, it is also desired that a longitudinal seal allows easy mounting in a heat exchanger shell, and is cost-efficient. A good compromise has for example been found in the baffle seal profiles developed and marketed under the name T4 by Kempchen & Co. GmbH of Oberhausen, Germany. Principles of these seals are also described in U.S. Pat. No. 4,215,745, which also discusses other prior art seals.

The known longitudinal seals comprise a U-shaped flange that faces inwardly into the heat exchanger and that is sized to snugly receive the longitudinal baffle. A sealing member at the opposite side of the seal comprises an outwardly extending pair of flanges that elastically presses against the inner wall of the shell.

In many cases a two-shell-pass heat exchanger is not an optimal arrangement. For example, when an existing single pass heat exchanger is to be retrofitted with new internals, the positions of the fluid inlet and outlets of the shell are located at opposite ends longitudinally along the heat exchanger shell, and that can normally not be changed. For a two-pass arrangement, however, shell inlet and outlet should be arranged at the same longitudinal end of the shell.

A three-shell-pass arrangement, in which two longitudinal baffles are arranged so that the fluid flow in the shell meanders three times back and forth the length of the shell, would solve this problem. However, this is not done in practice, as reliable sealing of two longitudinal baffles poses practical problems. Since each of the longitudinal baffles is to be arranged a substantial distance away from a diameter of the shell, the baffles meet the shell at an angle considerably different from 90 degrees with the tangential. Due to this unusual geometry, sealing, e.g. by Kempchen seals, is seen as problematic. Also, seals such as Kempchen seals represent a significant cost factor, and for a three-pass arrangement four longitudinal seals would be required.

It is an object of the present invention to provide an arrangement of longitudinal baffles and seals that allows improved sealing in multi-shell-pass heat exchangers, in particular also for retrofitting heat exchangers.

It is a further object to provide a method of assembling a heat exchanger with two or more longitudinal baffles.

### SUMMARY OF THE INVENTION

To this end the present invention provides an assembly of baffles and seals for mounting in a heat exchanger shell, which assembly comprises

a plurality of longitudinal baffles;

at least one longitudinal seal,

wherein the assembly further comprises a wall member that is arranged to extend between spaced apart longitudinal baffles so as to form a double wall with the heat exchanger shell after mounting, and wherein the at least one longitudinal seal is arranged on the wall member and away from the longitudinal baffles so as to sealingly engage the wall member against the heat exchanger shell after mounting.

Applicant has realized that reliable sealing between two spaced apart longitudinal baffles in a multi-pass heat exchanger can be obtained if a wall member is provided that forms a double wall with the heat exchanger shell, and wherein the longitudinal seal is provided between the wall member and the heat exchanger shell. In this way an optimum position on the wall member can be chosen for the longitudinal seal, and/or the geometry between the seal and the shell can be can be optimised. Only one seal can be sufficient for sealing two edges of longitudinal baffles against the shell.

Typically, the shell is cylindrical, and the wall member has substantially the shape of an arc having a slightly smaller radius. Suitably the longitudinal seal extends radially outwardly from the wall member, and in the typical geometry the seal will meet the shell in a perpendicular orientation. Preferably, the longitudinal seal is mounted on a longitudinal strip that perpendicularly extends from the wall member.

Two longitudinal seals can be arranged on the wall member so as to form a sealed inner space with the heat exchanger wall after mounting. If then during normal operation fluid from one compartment were to leak along a longitudinal seal, the fluid will enter into the inner space of the double wall, and therefore not directly into another compartment. In order to leak into a further compartment the fluid would need to leak through yet another longitudinal seal. The double sealed wall member acts as a leakage barrier. Such a design can be particularly beneficial where highly reliable and robust sealing is required, e.g. in cases where the internals of the heat exchanger need to be regularly removed from the shell for inspection and/or cleaning.

Further, if a double seal is arranged on the wall member, a compressed gauze material can be provided as additional sealant, and arranged between the two longitudinal seals. Suitable compressed gauze materials are steel wool or compressed expanded metal.

Suitably, the longitudinal seal comprises a U-shaped flange for receiving a strip extending from the wall member. Suitably the longitudinal seal comprises a wall sealing member, which is formed of oppositely outwardly extending elastic flanges. A suitable such longitudinal seal is the baffle seal T4 of Kempchen & Co. GmbH, and also includes a U-shaped flange.

Suitably, the assembly further comprises a plurality of transverse baffles for supporting a bundle of tubes. The transverse baffles can comprise elements of expanded metal, as described in International patent applications No. WO2005/067170; WO2005/015107; WO2005/015108, which are incorporated by reference.

Alternatively the invention can also be used with other types of heat exchangers having a longitudinal flow pattern, examples are heat exchangers with rod baffle tube supports, or heat exchangers with twisted tubes.

When the assembly with n−1 longitudinal baffles is arranged to form a meandering fluid flow path of n passes between an inlet and an outlet after mounting in the heat exchanger shell, wherein n>2, the transverse baffles are suitably formed of n segments. The segments of transverse baffles between adjacent longitudinal baffles then suitably have a cross-section corresponding to the cross-section between opposing double walls of the adjacent longitudinal baffles.

In a special embodiment tubes extend from a tube sheet through the transverse baffles and an transverse end baffle to a tube end sheet, and the wall members are connected at one end to the tube sheet and at the other end to the end baffle. Preferably then the end baffle is provided with a seal so as to prevent bypass of fluid between shell passes around the end baffle.

The assembly can be prefabricated, optionally together with tubesheets and tubes passing through transverse baffles, and slid into the heat exchanger shell, in particular during a replacement operation. It can of course also be mounted directly in a heat exchanger shell.

The invention further provides a method of assembling a heat exchanger, the method comprising
providing a heat exchanger shell;
providing an assembly of baffles and seals, comprising
   a plurality of longitudinal baffles;
   at least one longitudinal seal; and
   a wall member, in particular providing an assembly according to the present invention; and further comprising
assembling the assembly of baffles and seals outside the heat exchanger shell so that an arrangement of stacked longitudinal baffles is obtained, wherein the wall member extends between spaced apart longitudinal baffles and wherein the at least one longitudinal seal is arranged on the wall member and away from the longitudinal baffles; and
introducing the arrangement into the heat exchanger shell so that the wall member is sealingly engaged via the at least one longitudinal seal against the heat exchanger shell.

During a revamp of an existing heat exchanger the step of providing a heat exchanger shell includes removing previous heat exchanger internals from that shell.

### BRIEF DESCRIPTION OF THE DRAWINGS

The invention will now be described in more detail and with reference to the accompanying drawings, wherein

FIG. 1 shows schematically an assembly of baffles and seals according to the invention;

FIG. 2 shows schematically an assembly of baffles and seals according to the invention in a heat exchanger;

FIG. 3 shows schematically a cross section through the heat exchanger of FIG. 2;

FIG. 4 shows schematically detail IV of FIG. 3 enlarged;

FIG. 5 shows schematically transverse expanded metal tube support baffles for use with the present invention; and

FIG. 6 shows schematically a bundle of tubes passing through expanded metal.

Where the same reference numerals are used in different Figures, they refer to the same or similar objects.

### DETAILED DESCRIPTION OF THE INVENTION

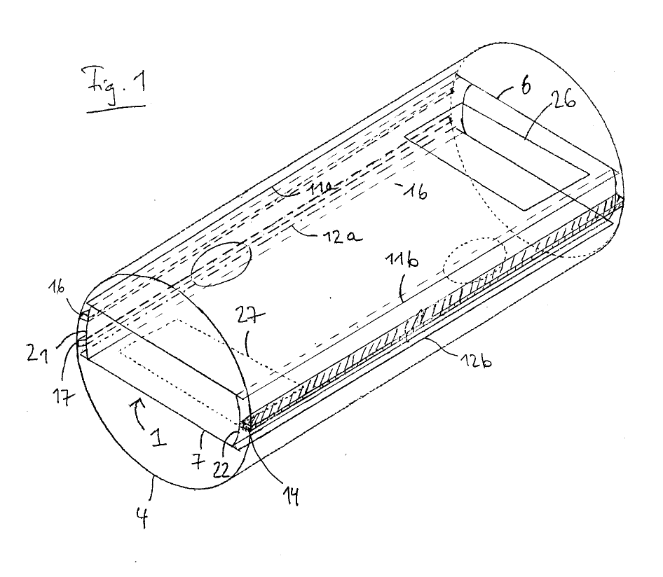

FIG. 1 shows schematically a three-dimensional view of an assembly 1 of baffles and seals according to the present invention. For the sake of clarity part of a heat exchanger shell 4 is indicated around the assembly, but it will be understood that the shell 4 does in general not need to form part of the assembly.

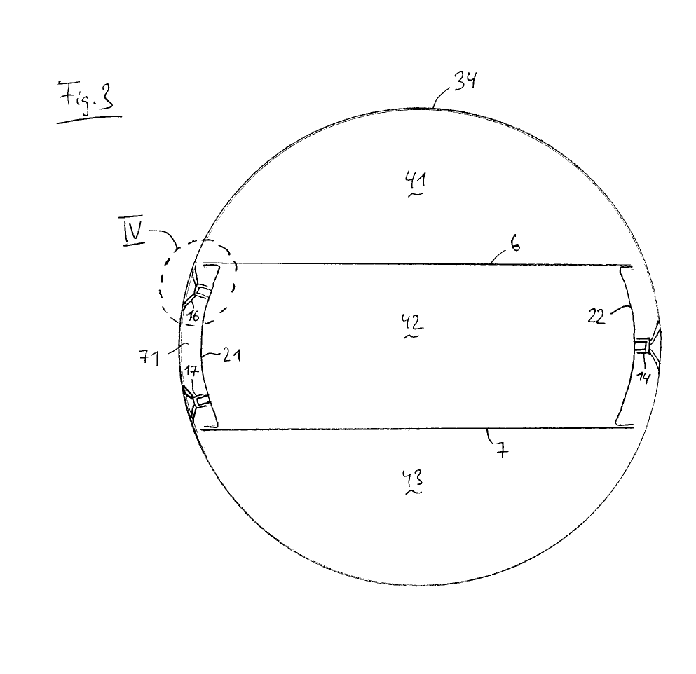

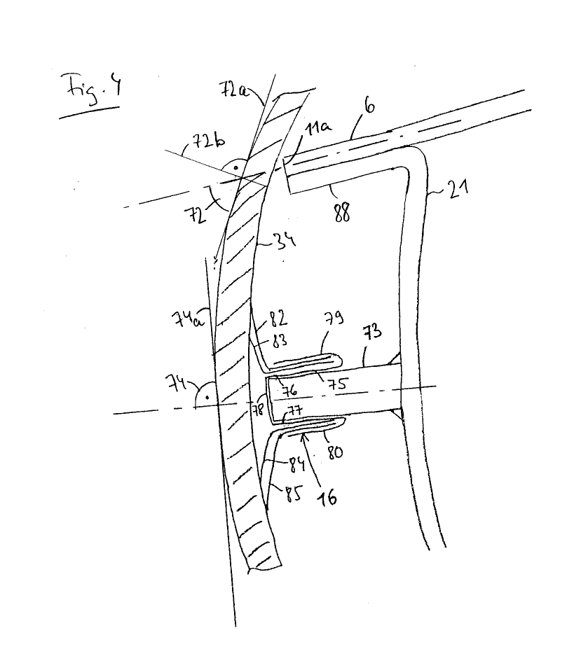

The assembly comprises two spaced apart longitudinal baffles 6,7 each having a pair of longitudinal rims 11a,b;12a,b and dividing the interior space of the heat exchanger 1 into three compartments. The assembly further comprises wall members 21 and 22 that extend between the longitudinal baffles 6,7, near rims 11a,12a; and 11b,12b, respectively. The wall members form a double wall with the heat exchanger shell 4 after mounting, and represent the longitudinal transverse walls of the middle compartment of the heat exchanger 1 For the sake of illustration of two embodiments, wall member 22 is provided with one longitudinal seal 14, and wall member 21 is provided with two longitudinal seals 16,17, for sealingly engaging the wall members against the heat exchanger shell 4 after mounting in the shell. The wall members and seals are only shown schematically, and more details of an embodiment thereof will be discussed with reference to FIGS. 3 and 4.

The single seal 14 of wall member 22 is cost-efficient, since only one longitudinal seal with the shell is required for two longitudinal rims of two longitudinal baffles.

The longitudinal baffles 6,7 are provided with substantially rectangular cut-outs 26,27, that allow meandering fluid flow between the thee compartments that are formed in a shell.

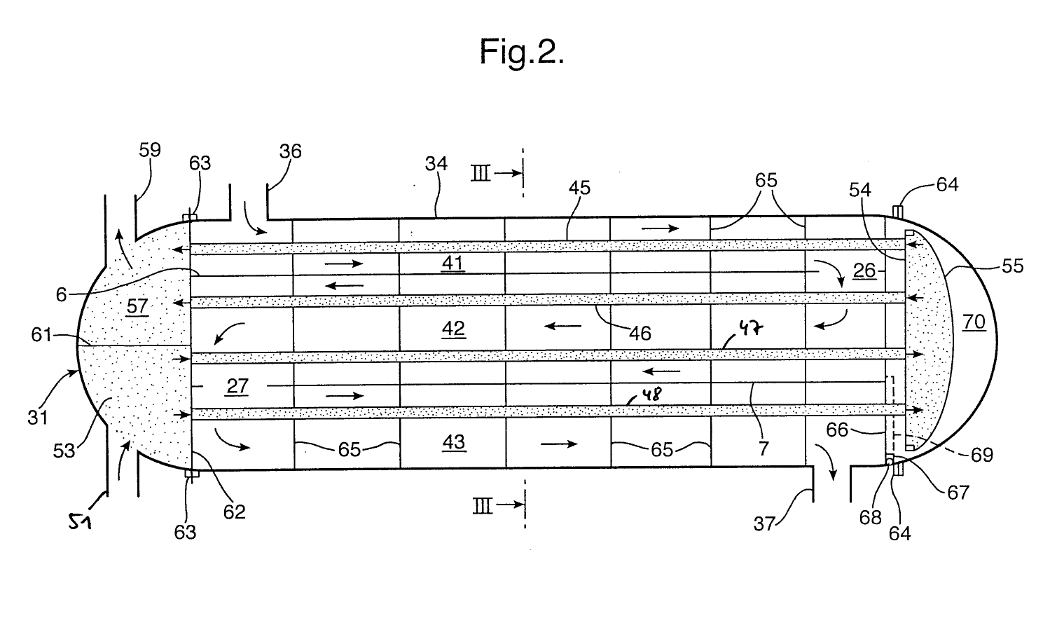

Reference is made to FIG. 2 showing schematically the assembly 1 mounted in a heat exchanger 31 with heat exchanger shell 34. The heat exchanger shell 34 has an inlet 36 at its upper side near one longitudinal end, and an outlet 37 at the lower side at the opposite longitudinal end. The longitudinal baffles have a width slightly smaller than the width of the shell at their mounting position so that the longitudinal outer rims of each baffle plate are spaced slightly inwardly, typically 2-20 mm, from the inner wall surface of the shell. The longitudinal baffles partition the interior of the shell 34 into three compartments 41,42,43 which are in fluid communication via the cut-outs 26,27.

The heat exchanger is further provided with a tube bundle, only four tubes of which, tubes 45,46,47,48, are shown for the sake of clarity. The tube side of the heat exchanger 31 is indicated with dots. In this embodiment the tube side has a two-tube-pass arrangement. The tube side has an inlet 51 to a tube inlet header 53. The tube inlet header is in fluid communication with the lower part of the tube bundle, tubes 47,48, which extend to the tube end sheet 54 connected to the tubing end header 55 which in turn is in fluid communication with the upper part of the tube bundle, tubes 45,46, extending into the tube outlet header 57 where the outlet 59 from the tube side is arranged. The inlet and outlet tube heads 53,57 are separated by a horizontal plate 61 extending horizontally along in the centre of the shell 34 from the shell end to the tube sheet 62 in which the tubes are fixed. The tube sheet is secured to the shell by flanges 63, through which the inlet end of the shell can be opened for inserting or removing the internals. Flanges 64 through which the end part of the shell can be removed are also arranged at the rear end.

The tube end sheet 54 at the opposite end also fixes the tubes, but unlike the tube sheet 62, the tube end sheet 54 and the tube end header 55 to which it is connected are not connected to the shell 34, i.e. the end header is floating. This allows thermal expansion of the tubes within the shell. Instead of an end header which receives and distributes all tube fluid also separate U-tubes could be applied.

The tubes are supported by a plurality of transverse baffles 65. The transverse baffle 66 that is farthest away from the tube inlet/outlet is different from the others. First of all, it is formed of a solid plate which is manufactured within tight tolerances to the cross-section of the shell, and is only provided with openings though which the tubes can just pass, but the tubes are not connected to this baffle plate. The end baffle 66 serves to prevent leaking of shell fluid from compartment 41 directly to compartment 43 by flowing around the tube header 55. By such leaking, shell fluid from the first pass would make a shortcut to directly reach the shell outlet 37, driven by the small pressure drop that exists between the different passes. To prevent this, a seal in the form of profile 67 is arranged that presses packing material 68 against the shell 34, at least in the lower part of the circumference of the end baffle 66 to above the baffle 7, as indicated dashed at 69. By this seal, leaking from the free space 70 around the tube end header 55 into the third pass, compartment 43, is prevented. The seal can extend around the entire circumference of end baffle 67, but that is not strictly required as leaking into the second pass, compartment 43, is not a problem as it does not constitute a shortcut, like in two-shell pass heat exchangers. The transverse baffles are suitably interconnected for mechanical stability, e.g. by longitudinal rods (not shown).

FIG. 3 shows a cross-section of the heat exchanger shell with the mounted arrangement of baffles and seals along the line III-III in FIG. 2 and reflecting the two embodiments from FIG. 1 with one or two longitudinal seals at either side. Tubes and transverse baffles are not shown. A double wall is formed by the shell 34 and the wall member 21, defining inner space 71. The shrouds 21,22 extend all the way from the tube sheet 62 to the end baffle plate 66 (cf. FIG. 2), and are sealingly connected to these. To this end flanges (not shown) are welded to the ends of the shrouds 21,22 which are bolted, using suitable packing material, to the tube sheet and end baffle plate, respectively.

The shrouds 21 and 22 are also sealingly connected to the longitudinal baffles 6,7.

An embodiment of the connection between wall member 21 and longitudinal baffle 6 as well as of the longitudinal seal 16 is shown as enlarged portion IV in more detail in FIG. 4, and the other longitudinal seals 14,17, can be analogously constructed.

The longitudinal baffle 6 meets the shell 34 at an angle 72 with the tangential 72a, that is smaller than 90 degrees, e.g. 80 degrees or less, i.e. significantly away from the normal 72b. Therefore, sealing of the longitudinal baffle directly at the longitudinal rim 11a is problematic. According to the invention, the wall member 21 is provided, and is sealingly connected with its folded rim 88 to the baffle 6 near the rim 11a, e.g. bolted and using packing material.

The longitudinal seal 16 is arranged on the wall member 21 through a strip 73. The seal may comprise a U-shaped flange 75 that is formed of inner flanges 76 and 77 connected via bottom flange 78, all made from one piece of strip metal. The strip metal is folded over to form folds 79 and 80. The folds are arranged to hold the wall sealing member in the form of elastic outwardly extending flanges, metal lamellae 82,83,84,85. Four lamellae are shown in the drawing, two to either side, but more or less lamellae seals can be arranged. A typical number is 4 lamellae to either side.

Alternatively the seal may comprise a gasket or any other sealing device known to those of ordinary skill in the art.

The groove formed by the U-shaped profile 75 has a width such that strip 73 is snugly received. If desired, packing material suitable for the operating temperatures such as Teflon can be applied. It will be understood that clearances between parts in the drawings are shown exaggerated for the sake of clarity.

The arc-shaped part of the wall member 21 runs substantially parallel with the shell 34. It has a radius smaller than the radius of the shell. The strip member 73 extends radially from the wall member 21, so that it extends substantially perpendicularly from the wall member and meets the wall 34 at an angle 74 which is substantially perpendicular with the tangential 74a. Substantially perpendicular is typically at an angle within 10 degrees from perpendicular, preferably within 5 degrees. In this way the lamellae 82,83 and 84,85 at either side of the seal are in a similar relative orientation with respect to the shell and can operate in the same way. This would not be the case if the longitudinal seal was arranged on the longitudinal rim 11a of the baffle 6, where the lamellae at either side would undergo substantially different deformation. The strip member 73 is suitably welded to the wall member 21, but it can also be fastened by other means or can be integrally formed with the wall member.

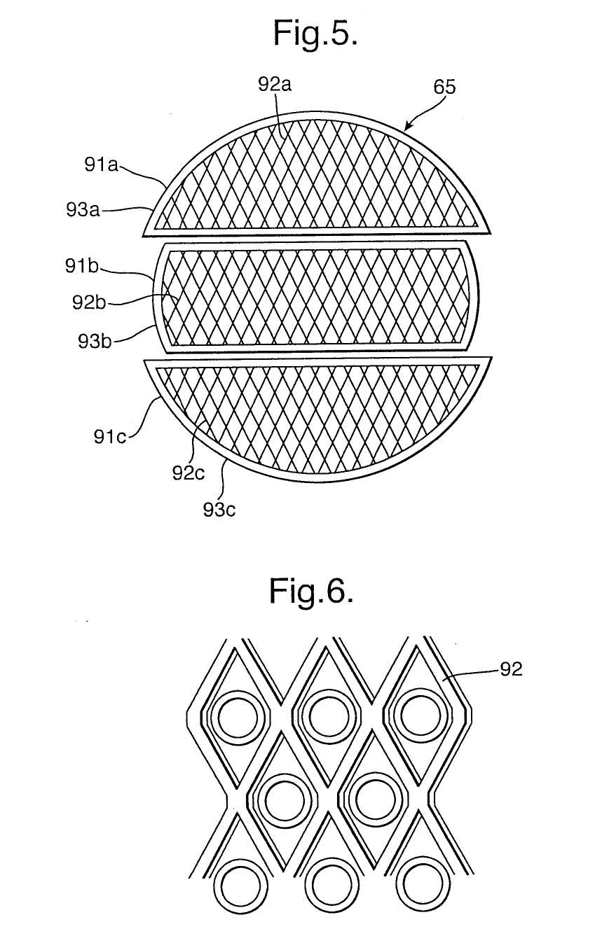

FIG. 5 shows a transverse baffle 65 which is formed of 3 segments 91a,91b,91c, thereby being adapted to cooperate with the two longitudinal baffles 6,7 in a three-shell-pass heat exchanger. The segments of this embodiment are made of expanded metal sheets 92a,b,c that are cut to size and welded to a frame 93a,b,c, which frame can be connected to the shell and/or to the longitudinal baffles as needed for mechanical stability.

The expanded metal 92 supports the tubes as schematically shown in FIG. 6.

Potentially one could have considered to fold the longitudinal rims, such as rim 11a in FIG. 4, so that it meets the shell in a near perpendicular orientation, so that sealing at the longitudinal baffle rims would be possible. This would however have the consequence that the transverse baffles need to follow that geometry, which makes manufacturing more complicated and expensive. The present invention provides an easier an cheaper solution.

For manufacturing a heat exchanger, a heat exchanger shell is provided, if needed after removing original internals. The assembly of baffles and seals according to the invention is preferably assembled outside the shell so that an arrangement of stacked longitudinal baffles provided with longitudinal seals is obtained, wherein wall members extend between adjacent longitudinal baffles. The assembly can be further completed with transverse baffles and tubes, and suitably with the tube sheet and tube end sheet, and the completed assembly can be slid into the shell. To this end, the tube inlet/outlet header is removed, and suitably also the end part (flanges 63 and 64 in FIG. 2). The tube end sheet 54 has a smaller diameter than the tube sheet 62, since it has to pass through the shell. The tube header 55 is suitably mounted after the assembled arrangement has been moved through the shell. Suitably sliding strips are arranged on the circumference of transverse baffles.

An example of normal operation of a heat exchanger with internals according to the present invention will now be described. The heat exchanger of this example is used in a pre-heat train of a crude distilling unit, wherein a previous shell-side single-pass segmental heat exchanger was revamped by installing an assembly similar to the one shown in FIGS. 2-6, with 2 seals per wall member. The overall length of the tubes is ca. 6 meters, the inner diameter of the cylindrical shell is ca. 1.2 meters. Kempchen T4 baffle seals are used, wherein the elastic lamellae seals are made from stainless steal 316 TI. The double wall formed an inner space of 50 mm width at either wall member, cf. reference numeral 71 in FIG. 3. No tubes could be arranged along the horizontal centreline of the shell because of the horizontal plate 61 separating tube inlet and outlet headers. A total of 866 tubes was installed.

The fluid passing through the tube side is crude, which is pre-heated, say from 155° C. to 180° C., against hot long residue that is passed through the shell side and cooling from 270° C. to 220° C. Use of expanded metal baffles is particularly advantageous in this case as it reduces fouling and maintenance/cleaning cost in the shell side. The three-shell-pass design increases the flow velocity in the shell side which is beneficial for high duty heat transfer in a compact shell. It also makes good use of the available pressure drop. A particularity of the layout of this example with three shell passes and 2 tube passes is that the shell and tube flows are counter-current in compartment 41, partly counter-current and partly co-current in compartment 42, and co-current in compartment 43.

It shall be understood that the invention can likewise be used with more than two longitudinal baffles. For example, with 3 longitudinal baffles, suitably four wall members are provided, and in particular four double walls can be arranged, two between the first and second, and two between the second and third longitudinal baffle. The longitudinal seals of the second (middle) longitudinal baffle preferably hold the folded longitudinal rims of the two wall members that extend upwardly and downwardly from that seal. In such a four-shell pass design the shell inlet and outlet are normally at the same end of the shell. Since in such a design a longitudinal baffle runs along a horizontal diameter of the shell, there is no conflict with the horizontal separation plate between tube inlet/outlet header.

1. An assembly of baffles and seals for mounting in a cylindrical heat exchanger shell, which assembly comprises
a plurality of longitudinal baffles;
at least one longitudinal seal,
wherein the assembly further comprises a wall member that is arranged to extend between spaced apart longitudinal baffles so as to form a double wall with the heat exchanger shell after mounting, and wherein the at least one longitudinal seal is arranged on the wall member and away from the longitudinal baffles so as to sealingly engage the wall member against the heat exchanger shell after mounting.

2. The assembly according to claim 1, wherein the longitudinal seal extends radially outwardly from the wall member, and wherein the longitudinal seal is mounted on a longitudinal strip that perpendicularly extends from the wall member.

3. The assembly according to claim 1, wherein two longitudinal seals are arranged on the wall member so as to form a sealed inner space with the heat exchanger shell after mounting.

4. The assembly according to claim 3, wherein the assembly further comprises a compressed gauze material between the two longitudinal seals.

5. The assembly according to claim 4, wherein the at least one longitudinal seal comprises a U-shaped flange for receiving a strip extending from the wall member.

6. The assembly according to claim 5, wherein the at least one longitudinal seal comprises a wall sealing member, which is formed of oppositely outwardly extending elastic flanges.

7. The assembly according to claim 6, wherein the assembly further comprises a plurality of transverse baffles for supporting a bundle of tubes, in particular wherein the transverse baffles comprise elements of expanded metal.

8. The assembly according to claim 7, wherein the number of longitudinal baffles is n−1 to create a meandering fluid flow path of n passes between an inlet and an outlet of the heat exchanger shell, wherein n>2, and wherein the transverse baffles are formed of n segments, in particular wherein the segments of transverse baffles between adjacent longitudinal baffles have a cross-section corresponding to the cross-section between opposing double walls of the adjacent longitudinal baffles.

9. The assembly according to claim 8, wherein tubes extend from a tube sheet through the transverse baffles and a transverse end baffle to a tube end sheet, and wherein the wall members are connected at one end to the tube sheet and at the other end to the end baffle.

10. The assembly according to claims 9, wherein the end baffle is provided with a seal so as to prevent bypass of fluid between shell passes around the end baffle.

11. The assembly according to claim 10, wherein the assembly is arranged in the heat exchanger shell.

12. A method of assembling a heat exchanger, the method comprising
providing a heat exchanger shell;
providing an assembly of baffles and seals comprising
a plurality of longitudinal baffles;
at least one longitudinal seal; and
a wall member;
assembling the assembly of baffles and seals outside the heat exchanger shell so that an arrangement of stacked longitudinal baffles is obtained, wherein the wall member extends between spaced apart longitudinal baffles and wherein the at least one longitudinal seal is arranged on the wall member and away from the longitudinal baffles; and
introducing the arrangement into the heat exchanger shell so that the wall member is sealingly engaged via the at least one longitudinal seal against the heat exchanger shell.

13. The method according to claim 12, wherein the step of providing a heat exchanger shell comprises removing previous heat exchanger internals from that shell.
